(19) United States
(12) Patent Application Publication
(10) Pub. No.: US 2015/0163148 A1
(43) Pub. Date: Jun. 11, 2015

(54) Packet Scheduling in a Communication Network

(71) Applicants: János Harmatos, Budapest (HU); Balázs Peter Gerö, Budapest (HU); Szilveszter Nádas, Budapest (HU); Sándor Rácz, Cegled (HU)

(72) Inventors: János Harmatos, Budapest (HU); Balázs Peter Gerö, Budapest (HU); Szilveszter Nádas, Budapest (HU); Sándor Rácz, Cegled (HU)

(73) Assignee: Telefonaktiebolaget L M Ericsson (publ), Stockholm (SE)

(21) Appl. No.: 14/395,836

(22) PCT Filed: Apr. 23, 2012
(86) PCT No.: PCT/EP2012/057347

§ 371 Date: Dec. 23, 2014

(51) Int. Cl. H04L 12/815; H04L 12/923; H04L 12/873

(52) U.S. Cl. CPC H04L 47/22; H04L 47/522; H04L 47/762

(57) ABSTRACT

A method and apparatus for packet scheduling over a communication link in a communication network. A data packet scheduler accords scheduling weights to at least two sets of data packets to be transmitted, and the sending of the sets of data packets is scheduled in accordance with the scheduling weights. When it is determined that a change in available bandwidth over the communication link has occurred, the scheduler dynamically adjusts the scheduling weight for each set of data packets on the basis of the available bandwidth. This ensures more efficient resource sharing control and resource guarantees when the available bandwidth changes.

### TECHNICAL FIELD

The invention relates to the filed of packet scheduling in a communication network.

### BACKGROUND

There are many types of transmission systems in communication networks. Each system is typically limited by a capacity of the maximum amount of data that can be carried at any given time. In order to address this, data packets to be sent via the communication network can be prioritized. Some types of data, such as peer to peer and file download data and emails, can tolerate being delayed in the network. Other types of data, such as audio or video in an session between two or more parties, cannot tolerate delays in the network, as this can impact on the quality of service that is provided to the parties. Delay-tolerant data can therefore be sent with a low priority, whereas delay-intolerant traffic can be sent with a higher priority. At times when the communication network is approaching full capacity, the delay-tolerant traffic can be withheld in favour of the delay-intolerant traffic to ensure that the quality of the delay-intolerant traffic is not impacted.

There are several schemes for prioritizing and scheduling data packets. One example is weighted fair queuing (WFQ). Data streams comprising data packets are accorded a “weight” that is used to determine how much of the bandwidth resources the data stream can use. Delay-intolerant data will be accorded a higher weight than delay-tolerant data.

Strict priority and/or WFQ queuing mechanisms are used among different Classes of Services (CoS) to control packet level resource sharing. FIG. 1 illustrates a resource sharing solution. User Equipment (UE) 1 sends data packets having two different CoS (shown by a dotted line and a dashed line) via a base station such as an eNodeB (2) over a radio bearer. Application level congestion control 3 (such as TCP) is applied to ensure best-effort traffic is sent between the UE 1 and a server 4. A scheduler 5 schedules the data packets, including non Guaranteed bit-rate (GBR) data packets, which are sent via a Serving Gateway (6) to a Packet Data Network Gateway (PDN GW) 7. The scheduler 5 uses WFQ to schedule the data packets.

The WFQ weights used are determined on the basis of the desired resource sharing and the actual capacity of the link. Examples of desired resource sharing, with an associated WFQ weight setting, are as follows:
Guarantee a fixed bitrate for a CoS. For example, it may be required to guarantee a bit-rate of 30 Mbps for a CoS over a shared 100 Mbps link. In this example, 100 Mbps is the dominant capacity. When determining WFQ weights, the normalized weight for this CoS must be at least 0.3.
Avoiding starvation of low priority traffic. Low priority traffic, such as data packets sent by a peer-to-peer (p2p) application can, when the bandwidth is being used by higher priority traffic, be throttled back so no low priority traffic is sent at all. In this case, the WFQ for this CoS can be given a low weight (e.g. 1/10) to avoid ‘starvation’ of this CoS. This ensures that low priority traffic has at least a guaranteed bandwidth share, and the remaining 90% of the bandwidth capacity is enough for higher priority traffic at the highest modulation.

The solutions described above to configure the scheduler 5 are static. A problem with these solutions arises when Adaptive Modulation is used, as this gives rise to variable link capacity. In wireless communication networks, link adaptation is used to refer to the matching of the modulation, coding and other signal and protocol parameters to the conditions on the radio link. Conditions may vary owing to, for example, interference from other signals, sensitivity, transmitter power and so on. Rate adaption algorithms are used to adapt the modulation according to the quality of the radio link. Adaptive Modulation systems require knowledge of the condition of the radio link, which can be easily measured at the receiver, and the information provided to the transmitter. The sending rate at the transmitter can therefore be dynamically adapted depending on the condition (and available bandwidth) of the radio link.

However, Adaptive Modulation of a radio link can result in variable link capacity, giving lower modulations with lower bitrates. In the example shown in FIG. 1, the parameters of the scheduler 5 (e.g. WFQ weights) are determined on the basis of the link capacity. In the case of Adaptive Modulation, the dominant modulation level is used to set the scheduling according to the corresponding capacity. The dominant modulation level can be, for example, the lowest (or highest) modulation depending on the applied design method.

Where the scheduler 5 is configured with static rules, as described above, and Adaptive Modulation is used, then the static rules used by the scheduler 5 can become non-optimal. Static settings cannot provide the guaranteed bandwidth for a CoS at lower modulation level (assuming that the static weights were optimized for highest modulation level). For example, consider the case where the bandwidth of a link changes from 100 Mbps to 50 Mbps due to a modulation change. A static weight of 0.3 weight guarantees only 15 Mbps for that CoS instead of 30 Mbps. It will be appreciated that when the weights are determined for the lowest modulation level, then the required bandwidth is guaranteed at all modulation levels. However, during normal operation (in other words, most of the time), a much higher bandwidth guarantee is unnecessarily provided for that CoS. This conservative static setting can be non-optimal for other CoS at higher modulation levels.

To further illustrate this by way of an example, consider the case where an operator wishes to use two types of CoSs. Both CoSs have the same priority, and so the desired resource sharing among them is equal sharing. However, the first CoS requires a minimal bandwidth guarantee. The bandwidth share between the CoSs should be 50%-50%, but the bandwidth share of the first class must be at least 30 Mbps if possible. Assume that at the highest modulation level the link capacity is 100 Mbps, but at lowest modulation level it is 50 Mbps. If a WFQ weight of 0.6 is set for the first CoS (based on the capacity of the lowest modulation level), the required 30 Mbps can be provided for the first CoS at all modulation level. However, the resource sharing among the two CoSs is not the desired 50%-50% sharing (the sharing will be 60%-40%). In other words, the first CoS that has higher minimal bandwidth guarantee has higher priority in bandwidth resource sharing, which is not desired

As a further example, when we low priority traffic, as described above, is accorded a WFQ weight, then it is guaranteed a bandwidth share even at lower modulation levels. In some circumstances, when the link is experiencing a lower bandwidth capacity, it may be desirable to allocate that share to a CoS with a higher priority (such as a CoS that requires a minimum absolute bandwidth). During normal operation, it is reasonable to accord a weight to the low priority traffic to avoid starvation, but at lower modulations it may be required to protect higher priority traffic first. Static configuration of WFQ weights does not allow for this.

### SUMMARY

It is an object of the invention to improve the scheduling of data packets when using Adaptive Modulation. According to a first aspect, there is provided a method of packet scheduling over a communication link in a communication network. A data packet scheduler accords scheduling weights to at least two sets of data packets to be transmitted, and the sending of the sets of data packets is scheduled in accordance with the scheduling weights. When it is determined that a change in available bandwidth over the communication link has occurred, the scheduler dynamically adjusts the scheduling weight for each set of data packets on the basis of the available bandwidth. This ensures more efficient resource sharing control and resource guarantees when the available bandwidth changes.

As an option, the scheduling weights for each set of data packets are dynamically modified by obtaining, for each set of data packets, scheduling weights stored at a database.

The method optionally includes determining that a change in a number of bearers of a set of data packets has occurred, and dynamically adjusting the scheduling weight for each set of data packets on the basis of the change in the number of bearers. By considering the number of ongoing bearers, more sophisticated resource sharing policies can be implemented. As a further option, the scheduling weights for each set of data packets are optionally dynamically adjusted using an algorithm taking into account the number of bearers of a set of data packets.

Each set of data packets is optionally identified by a Class of Service.

While the method may be used to account for a change in available bandwidth owing to any cause, it is particularly useful when the change in available bandwidth is caused by adaptive modulation of the communication link.

As an option, after dynamically adjusting the scheduling weights, a timer is started. No further scheduling weight adjustments are performed for the duration of the timer.

As an option, a number of bearers of a set of data packets is determined by either parsing signalling messages or analysing header information.

According to a second aspect, there is provided a data packet scheduler for scheduling data packets to be sent via a communication link in a communication network. The data packet scheduler is provided with a weight function for according scheduling weights to at least two sets of data packets. A scheduling function is provided for scheduling data packets in accordance with the scheduling weights. A processor is provided for determining that a change in available bandwidth over the communication link has occurred. The processor is arranged to dynamically adjust the scheduling weight for each set of data packets in accordance with the available bandwidth.

As an option, the data packet scheduler is provided with a database for storing scheduling weights to be accorded to each set of data packets.

As a further option, the processor is arranged to determine that a change in a number of bearers of a set of data packets has occurred, and dynamically adjust the scheduling weight for each set of data packets on the basis of the change in the number of bearers. As a further option, the scheduling weights for each set of data packets are dynamically adjusted using an algorithm taking into account the number of bearers of a set of data packets.

The data packet scheduler is optionally provided with a timer for starting a time after an adjustment in scheduling weights, during which no further scheduling weight adjustments are performed by the processor.

The processor is optionally arranged to determine a number of bearers of a set of data packets by any of parsing signalling messages and analysing header information.

According to a third aspect, there is provided a computer program comprising computer readable code which, when run on a data packet scheduler, causes the data packet scheduler to perform the method as described above in the first aspect.

According to a fourth aspect, there is provided computer program product comprising a computer readable medium and a computer program as described above in the third aspect, wherein the computer program is stored on the computer readable medium.

### BRIEF DESCRIPTION OF THE DRAWINGS

FIG. 1 illustrates schematically in a block diagram a network architecture for packet scheduling;

FIG. 2 illustrates schematically in a block diagram an example of data packet scheduling according to an embodiment of the invention;

FIG. 3 illustrates schematically in a block diagram an example of data packet scheduling in the event of Adaptive Modulation changes to the available bandwidth according to an embodiment of the invention;

FIG. 4 is a flow diagram illustrating steps of an embodiment of the invention;

FIG. 5 illustrates schematically in a block diagram an example of data packet scheduling on a per-Bearer basis according to an embodiment of the invention; and

FIG. 6 illustrates schematically in a block diagram a scheduler according to an embodiment of the invention.

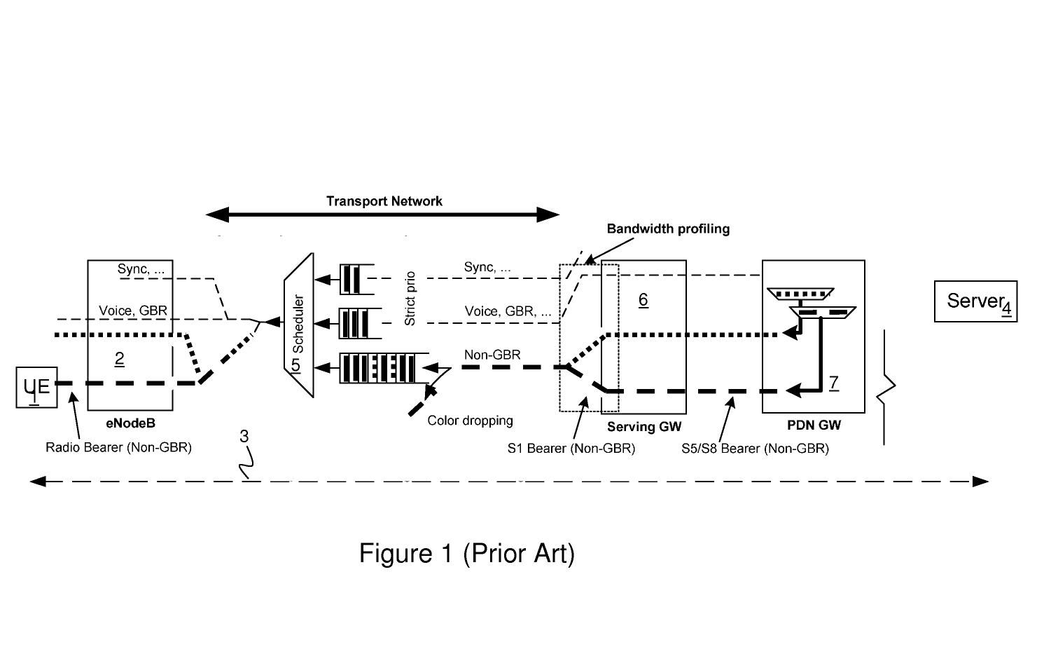

### DETAILED DESCRIPTION

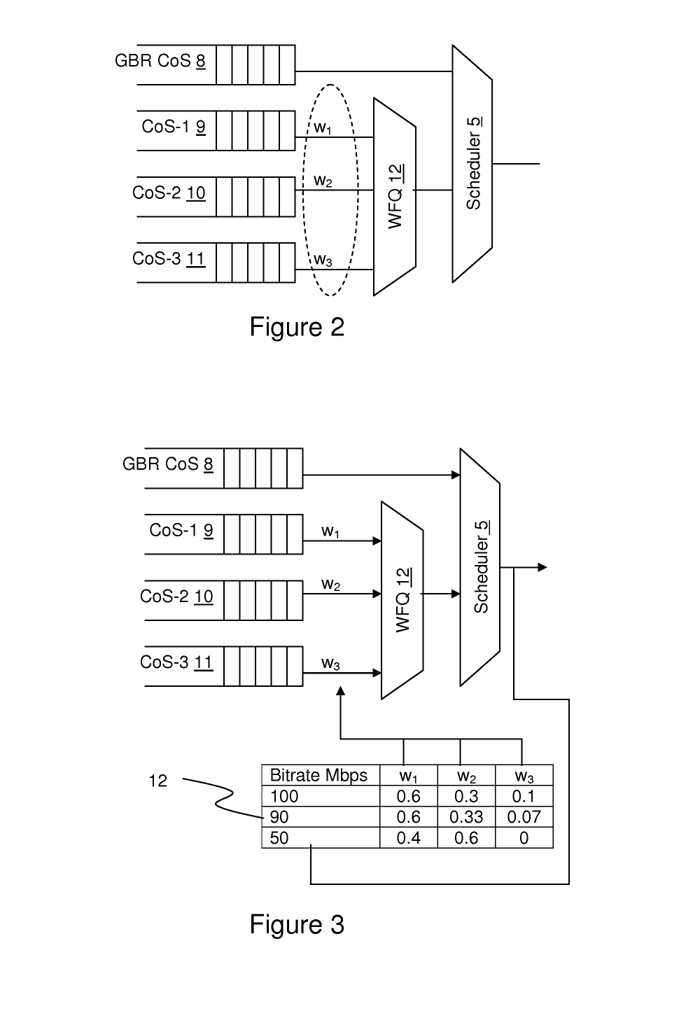

Data packet scheduling can be greatly improved if WFQ weights are dynamically modified as the available bandwidth increases or decreases as a result of Adaptive Modulation. FIG. 2 illustrates the case where there is one class of guaranteed bit-rate (GBR) traffic 8, a first non-GBR CoS 9, a second non-GBR CoS 10 and a third non-GBR CoS 11. The third non-GBR CoS 11 may be placed in a alternative queue for low priority traffic, such as p2p data packets. In the scheduler, the three non-GBR CoSs are scheduled using a WFQ function 12.

The WFQ weights of the three non-GBR CoSs are modified dynamically depending on the current state of Adaptive Modulation of the link. Consider the example in which the first non-GBR CoS requires a guaranteed bit-rate. In the event that Adaptive Modulation causes the available bandwidth to reduce, the WFQ weight for the first non-GBR CoS 9 is increased to ensure that it maintains its guaranteed bit-rate. This may be used, for example, for an Over the Top (OTT) service that requires a bandwidth guarantee for proper operation.

For the low-priority non-GBR Cos 11, its weight is decreased in the event that the Adaptive Modulation causes the available bandwidth to reduce. For example, at lower modulations, a weight of 0 may be set for the third non-GBR CoS to ensure that all available bandwidth is used for higher priority traffic. Of course, when the Adaptive Modulation leads to the available bandwidth increasing, the WFQ weight of the low-priority non-GBR traffic can be increased once more.

Per-Bearer level information (e.g. #ongoing Bearers) may also be used when dynamically adjusting the WFQ weights for different CoSs, as described in more detail below.

The WFQ weight settings are typically dynamically adjusted when Adaptive Modulation causes a change in the available bandwidth, as illustrated in FIG. 3. The scheduler 5 is provided with data in the form of a table 12 that includes a weight for each CoS and for each modulation level (bit-rate). When the modulation level changes then scheduler 5 consults the table 12 and updates the WFQ weights for each CoS accordingly.

The scheduler may be provided with a prohibit timer to avoid to frequent WFQ reconfiguration. For example, if a 100 ms timer is used then once a WFQ is adjusted as a result of Adaptive Modulation, no further WFQ adjustments can be made until 100 ms have elapsed.

In the example shown in FIG. 3, the required resource sharing for each CoS is as follows:
The first CoS 9 requires a large bandwidth, and so requires a high bandwidth share. However, it is not critical for the first CoS 9 to have the high bandwidth all the time, so there is no requirement for a bandwidth guarantee. An example of a type o data packet that might fall under this CoS is premium Internet access.
The second CoS 10 requires a bandwidth of at least 30 Mbps all the time regardless of the link conditions and the Adaptive Modulation level (in this example, it is assumed that there negligible traffic over the GBR CoS 8). This CoS requires a high (but not guaranteed) bandwidth share, but the absolute bandwidth guarantee is more important. An example of data packets that fall under this CoS is OTT services that require (soft) bandwidth guarantees. An alternative solution is to put this class into a higher priority queue and using a 30 Mbps shaper. However, in this case the CoS does not have the potential of using a larger bandwidth than 30 Mbps, even when other CoSs are not using the available bandwidth.
The third CoS 11 is used for low priority traffic. It is preferable, but not necessary, to avoid starvation for this class. This can be used for e.g. non-premium Internet access or special access provided for p2p traffic.

The settings shown in the table 12 result in the second CoS 10 having a bandwidth of at least 30 Mbps regardless of the total available bandwidth. The first CoS 9 maintains a high bandwidth share at all times, but this is necessarily reduced in the event that the total available bandwidth falls to 50 Mbps, in order to ensure that the second CoS 10 maintains the required bandwidth of 30 Mbps. The third CoS 11 has its bandwidth share reduced in the event that the available bandwidth is reduced, and in the event of a large reduction of the available bandwidth from 100 Mbps to 50 Mbps, the third CoS 11 is accorded a WFQ weight of 0.

The above mention solution can not be realized by using static WFQ setting, even if rate limiters are used.

In order to apply WFQ weights dynamically according to the Adaptive Modulation, the scheduler 5 needs to be aware of the state of the link and the available bandwidth.

This requires the scheduler to receive information about Adaptive Modulation from a transmitter over which the data packets are being sent.

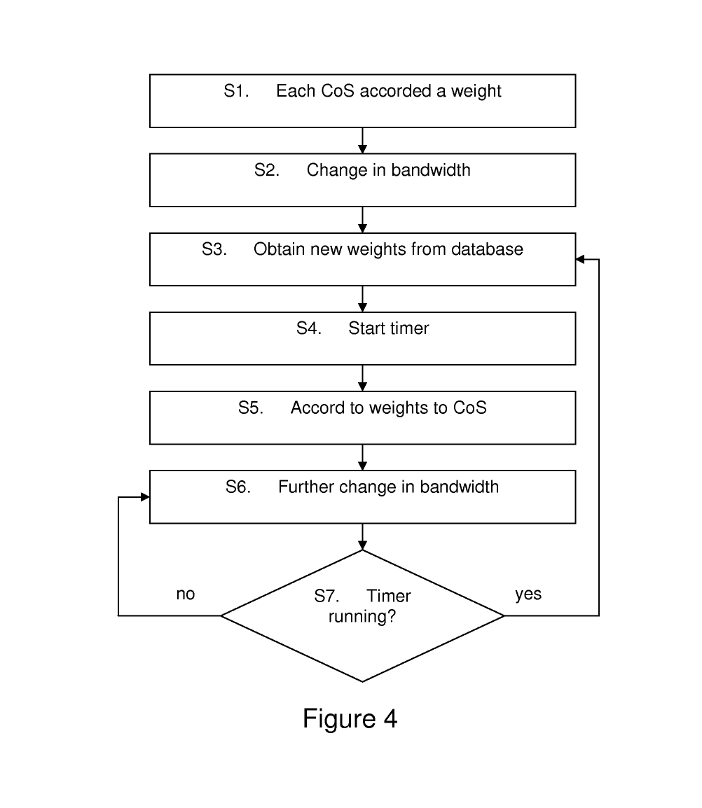

FIG. 4 is a flow diagram illustrating steps of an embodiment of the invention, with the following numbering corresponding to that of FIG. 4:

S1. Each CoS is accorded a weight for use in packet scheduling, and the scheduler 5 sends the data packets over the communication link according to the weight for each CoS;

S2. Adaptive modulation causes a change in the available bandwidth over the communication link. This change is communicated to the scheduler 5.

S3. The scheduler 5 looks up the new bandwidth in a database and obtains new weights for each CoS from the database.

S4. A timer is started.

S5. The new weights obtained from the database are accorded to each CoS.

S6. A further change in bandwidth is detected.

S7. If the timer is still running, then no changes are made to the weights. If the timer is no longer running, then new weights are obtained from the database and the method reverts to step S3.

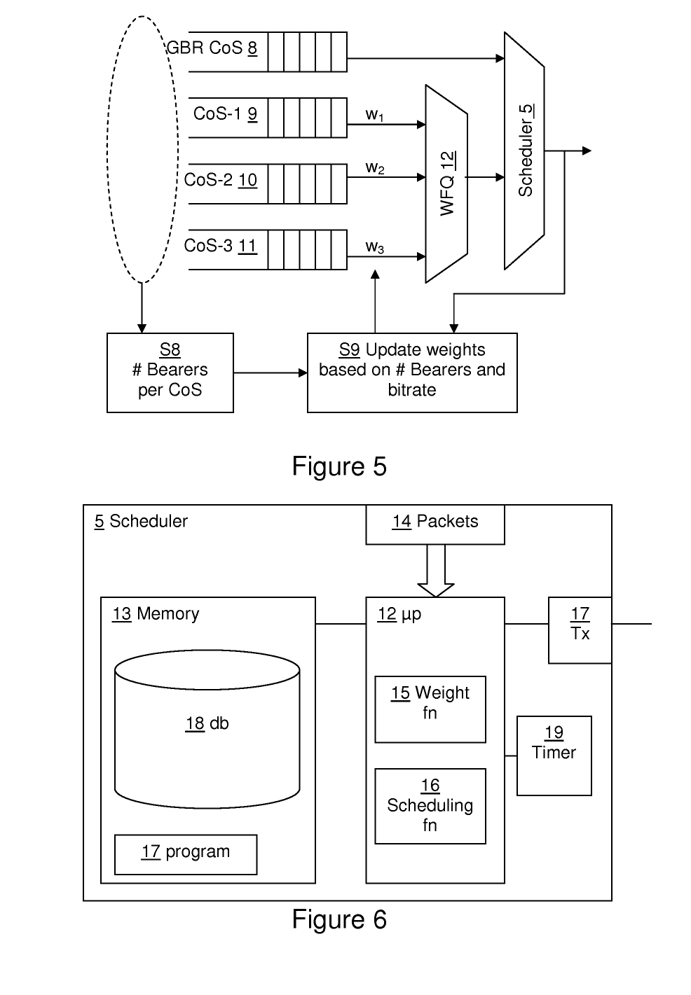

As mentioned above, per-Bearer level information (e.g. #ongoing Bearers) can be taken into account when dynamically adjusting the weight settings. Considering the number of ongoing Bearers allows more sophisticated resource sharing policies to be supported by the scheduler 5. This also allows bandwidth guarantee to be provided at the bearer level, which gives finer control than simply providing bandwidth guarantee for a particular CoS. FIG. 5 shows the steps of an embodiment that uses per-Bearer level information, with the following numbering corresponding to that of FIG. 4:

S8. A determination is made of the number of ongoing Bearers per CoS. This determination may be made using, for example, header information such as a Tunnel End-point Identifier (TEID), or parsing signalling messages.

S9. The WFQ weights for each CoS are recalculated in the event of a change in the capacity of the link owing to Adaptive Modulation, and/or in the event of a change in the number of Bearers used by a CoS. For example:
w₁=#Bearer1×4;
w₂=#Bearer2×2 and
if C>20 Mbps then
   w₃=#Bearer3
else
   w₃=0.

In this example, the settings are used when the first CoS 9 is a gold class service with a weight of 4, the second CoS 10 is a silver class service with a weight of 2 and the third CoS 11 is a bronze class service with a weight of 1, but at lowest modulation it is down-prioritized.

Note that modifying the WFQ weights for each CoS on the basis of per-Bearer information may be performed separately from modifying the WFQ weights for each CoS on the basis of Adaptive Modulation changing the conditions of the link. However, this has certain drawbacks. For example, frequent changes in the number of bearers cause frequent changes in WFQ weights. Furthermore, a single bearer arrival/termination would only lead to a negligible changing of WFQ weights. However, it is advantageous to change WFQ weights on the basis of both the per-Bearer information and Adaptive Modulation changing the conditions of the link, as it allows the current link conditions and traffic situation to be considered.

The number of number of bearers in each traffic class may be considered when setting new WFQ weights when the link capacity changes.

FIG. 6 illustrates a scheduler 5 according to an embodiment of the invention. The scheduler is provided with a processor 12 and a computer readable medium in the form of a memory 13. The processor 12 receives data packets from a packet source 14 in order to perform scheduling. In order to do this, a weight function 15 and a scheduling function 16 are provided, typically provided by the same processor 12, although it will be appreciated that these functions may be performed by different processors. A transmitter 17 is provided for sending scheduled data packets according to their assigned weights over a communication link. The transmitter 17 may feed information back to the processor about the available bandwidth and the state of adaptive modulation. The processor 12 is arranged to dynamically adjust the scheduling weight for each set of data packets. The processor 12 may also be used to determine the number of bearers of a set of data packets by, for example, of parsing signalling messages or analysing header information.

The memory 13 stores a program 17 which, when executed by the processor 12, causes the scheduler 5 to behave as described above. The memory 13 may also include a database 18 which stores information correlating available bandwidth, weights and CoSs. It will be appreciated that the database 18 may be located remotely from the scheduler 5.

As described above, a timer 19 may also be provided to ensure that weights are not dynamically adjusted too rapidly.

In practice, the scheduler 5 is typically embodied at a function provided at an existing transport node, examples of which include switches, routers, and microwave transmission nodes.

The techniques described above give improved resource sharing control and resource guarantees during adaptive modulation at both CoS and Bearer level. The dynamic adjustment of weights means that the scheduler reconfigures weights whenever the modulation level is changed.

It will be appreciated by the person of skill in the art that various modifications may be made to the above described embodiments without departing from the scope of the present invention as defined in the appended claims.

The following abbreviations have been used in this specification:

### CoS Class of Service

### GBR Guaranteed Bit Rate

### OTT Over the Top

p2p Peer to peer

### PDN GW Packet Data Network

### Serving GW Serving Gateway

### TCP Transmission Control Protocol

### TEID Tunnel Endpoint Identifier

WFQ Weighted Fair Queuing

1-16. (canceled)

17. A method of packet scheduling over a communication link in a communication network, the method comprising, at a data packet scheduler:
according scheduling weights to at least two sets of data packets and scheduling data packets in accordance with the scheduling weights;
determining that a change in available bandwidth over the communication link has occurred; and
dynamically adjusting the scheduling weight for each set of data packets on the basis of the available bandwidth.

18. The method according to claim 17, wherein dynamically adjusting the scheduling weights for each set of data packets comprises obtaining, for each set of data packets, scheduling weights from a database that correlates scheduling weights to available bandwidth.

19. The method according to claim 17, wherein there is a number of bearers for each set of data packets, and wherein the method further comprises determining that a change in the number of bearers for one of the sets of data packets has occurred, and dynamically adjusting the scheduling weight for each set of data packets on the basis of the change in the number of bearers.

20. The method according to claim 19, further comprising determining the number of bearers for each set of data packets by at least one of: parsing signaling messages; and analyzing header information.

21. The method according to claim 19, wherein the scheduling weight for each set of data packets is dynamically adjusted using an algorithm taking into account the number of bearers for the set of data packets.

22. The method according to claim 17, wherein each set of data packets is identified by a Class of Service.

23. The method according to claim 17, wherein the change in available bandwidth is caused by adaptive modulation over the communication link.

24. The method according to claim 17, further comprising, after dynamically adjusting the scheduling weights, starting a timer and performing no further scheduling weight adjustments for the duration of the timer.

25. A data packet scheduler for scheduling data packets to be sent via a communication link in a communication network, the data packet scheduler comprising a processor configured to:
accord scheduling weights to at least two sets of data packets;
schedule data packets in accordance with the scheduling weights;
determine that a change in available bandwidth over the communication link has occurred; and
dynamically adjust the scheduling weight for each set of data packets on the basis of the available bandwidth.

26. The data packet scheduler according to claim 25, further comprising a memory storing a database that correlates scheduling weights to available bandwidth, and wherein the processor is configured to dynamically adjust the scheduling weights for each set of data packets by obtaining the scheduling weights from the database according to the change in available bandwidth.

27. The data packet scheduler according to claim 25, wherein there is a number of bearers for each set of data packets and wherein the processor is further arranged to determine that a change in the number of bearers for one of the sets of data packets has occurred and dynamically adjust the scheduling weight for each set of data packets on the basis of the change in the number of bearers.

28. The data packet scheduler according to claim 27, wherein the processor is arranged to determine the number of bearers for each set of data packets by at least one of: parsing signaling messages; and analyzing header information.

29. The data packet scheduler according to claim 27, wherein processor is further arranged to dynamically adjust the scheduling weight for each set of data packets taking into account the number of bearers for the set of data packets.

30. The data packet scheduler according to claim 25, wherein the processor is configured to start a timer responsive to dynamically adjusting the scheduling weights, and to prevent further adjustment of the scheduling weights until expiration of the timer.

31. A non-transitory computer-readable medium storing a computer program, comprising computer program instructions for execution by a processor of a packet scheduler that is configured to schedule data packets to be sent via a communication link in a communication network, said computer program including program instructions to cause the processor to:
accord scheduling weights to at least two sets of data packets;
schedule data packets in accordance with the scheduling weights;
determine that a change in available bandwidth over the communication link has occurred; and
dynamically adjust the scheduling weight for each set of data packets on the basis of the available bandwidth.

32. A method of scheduling the communication of data packets over a communication link that is subject to dynamic link adaptations that change an available bandwidth of the communication link, said method comprising:
scheduling data packets associated with different data streams according to corresponding scheduling weights that control resource sharing of the available bandwidth by the different data streams;
determining that the available bandwidth of the communication link has changed to a new bandwidth; and
dynamically adapting the scheduling weights for the different data streams according to the new bandwidth, to thereby adapt the resource sharing of the new bandwidth by the different data streams.
